(19) United States
(12) Patent Application Publication
(10) Pub. No.: US 2007/0126554 A1
(43) Pub. Date: Jun. 7, 2007

(54) Multiple RFID reader system and method for controlling multiple RFID readers in the same

(76) Inventors: Sung Whan Choi, Daejeon (KR); Jong Un Won, Daejeon (KR); Jong Heung Park, Daejeon (KR); Sung Wook Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/634,626

(22) Filed: Dec. 6, 2006

(30) Foreign Application Priority Data
Dec. 7, 2005 (KR) 10-2005-0118953
May 30, 2006 (KR) 10-2006-0049060

(51) Int. Cl. H04Q 5/22

(52) U.S. Cl. 340/10.1; 340/572.1; 340/10.2

(57) ABSTRACT

A multiple RFID reader system for controlling operations of multiple RFID readers is provided. To minimize radio interference between multiple RFID readers, when a new RFID reader connects to the system, the system calculates probabilities of radio interference between the new RFID reader and already connected RFID readers and creates a radio interference logical operation list using the calculated radio interference probabilities. When it has been requested that the new RFID reader be activated, the system compares the created radio interference logical operation list with a list of currently running RFID readers and decides whether or not to activate the new RFID reader based on the comparison.

### RELATED APPLICATION

The present application is based on, and claims priority from, Korean Application Number 10-2005-0118953, filed Dec. 7, 2005 and Korean Application Number 10-2006-0049060, filed may 30, 2006, the disclosure of which is incorporated by reference herein in its entirety.

### BACKGROUND OF THE INVENTION

1. Field of the Invention

The present invention relates to a multiple RFID reader system, and more particularly to a multiple RFID reader system and a method for controlling multiple RFID readers in the system, which minimizes radio interference caused when the RFID readers are running simultaneously.

2. Description of the Related Art

Radio Frequency Identification (RFID) tags were attached to products when RFID was initially introduced. Distribution network design and manufacturing processes are expected to be developed using RFID data. The ultimate purpose of using RFID data is to maximize the visibility and tracking properties of information, for example, by applying the RFID data to a business processor and operating it in conjunction with an existing information system in real time.

However, a general RFID system including multiple RFID readers has a problem in that, when the multiple RFID readers are running simultaneously, radio interference occurs between adjacent RFID readers, thereby reducing their identification rates and thus reducing the operation efficiency of the system.

### SUMMARY OF THE INVENTION

Therefore, the present invention has been made in view of the above problems, and it is an object of the present invention to provide a multiple RFID reader system and a method for controlling multiple RFID readers in the system, which uses a multiple reader radio interference prevention algorithm to minimize radio interference caused when the RFID readers are running simultaneously due to their radio characteristics.

It is another object of the present invention to provide a multiple RFID reader system and a method for controlling multiple RFID readers in the system, wherein, when it has been requested that an RFID reader be activated, the system decides whether or not to activate the RFID reader using a radio interference logical operation list created through radio interference probability calculation.

In accordance with one aspect of the present invention, the above and other objects can be accomplished by the provision of a method for controlling multiple Radio Frequency Identification (RFID) readers in a multiple RFID reader system, the method comprising registering environment information of an RFID reader when the RFID reader is newly connected to the system; calculating respective probabilities of radio interference between the newly connected RFID reader and already connected RFID readers; creating a radio interference logical operation list using the calculated radio interference probabilities; comparing the created radio interference logical operation list with a list of currently running RFID readers when a request to activate the newly connected RFID reader has been made; and deciding whether or not to activate the newly connected RFID reader according to the comparison.

Preferably, the method further comprises removing registered environment information of an RFID reader, when a request to remove the RFID reader has been made, and updating the radio interference logical operation list; and releasing connection of the RFID reader which has been requested to be removed.

In accordance with another aspect of the present invention, there is provided a multiple RFID reader system comprising a reader environment information manager that registers a new RFID reader when the new RFID reader is connected to the system and manages environment information of already connected RFID readers; a radio interference probability manager that calculates and manages respective probabilities of radio interference between the new RFID reader and the already connected RFID readers; a list manager that creates and manages a radio interference logical operation list using the calculated radio interference probabilities; and a reader connection manager that manages connection of all the connected RFID readers and, when a request to activate the new RFID reader has been made, decides whether or not to activate the new RFID reader by comparing the created radio interference logical operation list with a list of currently running RFID readers.

Preferably, the method further comprises a reader activation queue that, when the request to activate the new RFID reader has been denied, stores information of the new RFID reader and makes a request to activate the new RFID reader after a specific time to allow the reader connection manager to again decide whether or not to activate the new RFID reader.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a multiple RFID reader system according to an embodiment of the present invention;

FIGS. 2a and 2b are flow charts of a procedure for preventing radio interference in the multiple RFID reader system according to an embodiment of the present invention; and

FIG. 3 is a flow chart of a procedure for preventing radio interference in the multiple RFID reader system when a reader is removed according to an embodiment of the present invention.

### DESCRIPTION OF THE PREFERRED EMBODIMENTS

Preferred embodiments of the present invention will now be described in detail with reference to the accompanying drawings. In the following description of the present invention, a detailed description of known functions and configurations incorporated herein will be omitted when it may obscure the subject matter of the present invention.

A multiple Radio Frequency Identification (RFID) reader system including multiple RFID readers and a method for controlling operations of adjacent readers having a high probability of causing radio interference when they run simultaneously in the multiple RFID reader system will now be described in detail with reference to the drawings. The multiple RFID reader system applies a multiple reader radio interference prevention algorithm to prevent readers from running simultaneously when they have a high probability of causing radio interference.

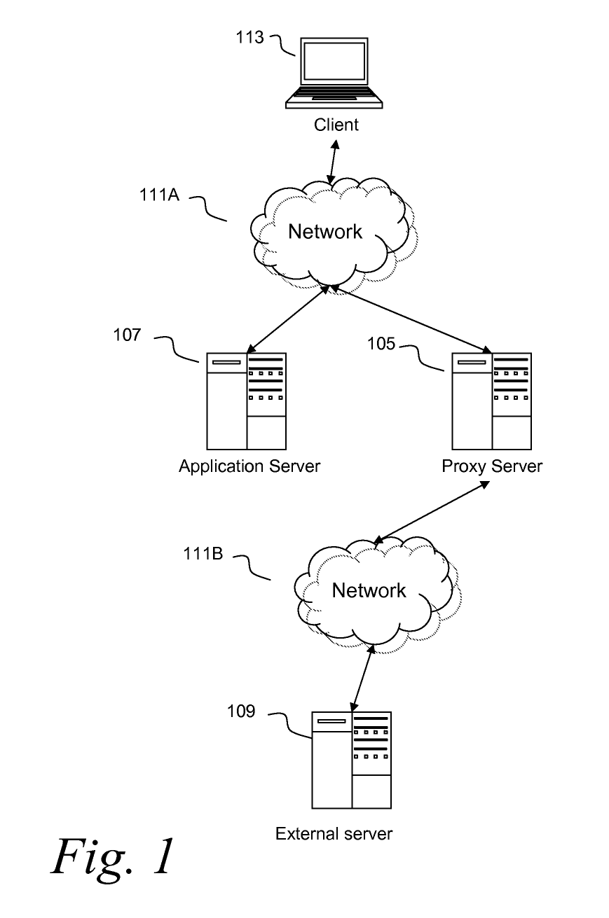

FIG. 1 is a block diagram of a multiple RFID reader system according to an embodiment of the present invention.

As shown in FIG. 1, the multiple RFID reader system includes a multiple RFID reader control system 100 that is connected to a plurality of RFID readers 11 to 16 to control operations of the RFID readers. This multiple RFID reader system will be described with reference to an example in which the RFID reader 11 is a new RFID reader that requests a connection to the multiple RFID reader control system 100 as shown by a dotted line and the remaining RFID readers 12, 13, 14, 15, and 16 have already been connected to the multiple RFID reader control system 100 as shown by solid lines. In the following description, an RFID reader is referred to as a reader for short for ease of explanation.

The multiple RFID reader control system 100 includes a reader connection manager 110, a radio interference probability manager 120, a list manager 130, a reader activation queue 140, and a reader environment information manager 150. The multiple RFID reader control system 100 controls operations of the readers 11 to 16 using a multiple reader radio interference prevention algorithm.

The reader connection manager 110 manages connection of all the added or removed readers 11 to 16. The reader connection manager 110 detects an IP address of the connection requesting reader 11 and then transmits environment information of the reader 11 to the environment information manager 150 and registers the environment information in the environment information manager 150. When it is requested that a reader be activated, the reader connection manager 110 reads registered environment information of all the connected readers 11 to 16 from the environment information manager 150. The readers 11 to 16 are connected to the multiple RFID reader control system 100 based on a network technology using a TCP/IP protocol. The reader connection manager 110 also retrieves a radio interference logical operation list of the reader 11, receives a list of readers 12 to 16 that are running, determines whether or not any reader included in the running reader list is included in the radio interference logical operation list, and decides whether or not to activate the reader 11 based on the determination.

The radio interference probability manager 120 calculates distances between the reader 11 and the readers 12 to 16 using their position information included in the environment information read from the reader connection manager 110, calculates probabilities of radio interference between the reader 11 and the readers 12 to 16 based on the calculated distances, and manages the calculated probabilities.

Based on the calculated radio interference probabilities, the list manager 130 generates and manages a list of readers each of which cannot run simultaneously with the reader 11, which is referred to as a “radio interference logical operation list”. The list manager 130 creates the radio interference logical operation list by comparing the calculated radio interference probabilities with a threshold and selecting readers, the calculated radio interference probabilities of which are higher than the threshold, and then writing IDs and IP addresses of the selected readers. The selection of readers can be made using Exclusive OR (XOR) operations. For example, if readers with calculated radio interference probabilities higher than the threshold are each set to “1” and the other readers are each set to “0”, and all reference values to be compared respectively with the calculated probabilities of the readers are set to “0”, then the readers set to “1” can be selected through XOR operations. It should be noted that using the XOR operations is set forth herein only for illustrative purposes and readers with radio interference probabilities higher than the threshold can be selected using other operations or calculations.

The radio interference logical operation list is checked before each of the readers 11 to 16 is activated and is then used to decide whether to activate each reader 11 to 16.

The reader environment information manager 150 manages environment information such as position information, IP addresses, reader types, and priorities of all readers used for operation of the system and dynamically updates the environment information when a reader is added or removed or when the environment information is changed.

A method for controlling the operations of connected RFID readers to minimize probabilities of radio interference between the RFID readers when they are running in the multiple RFID reader system according to the present invention will now be described in detail with reference to the accompanying drawings.

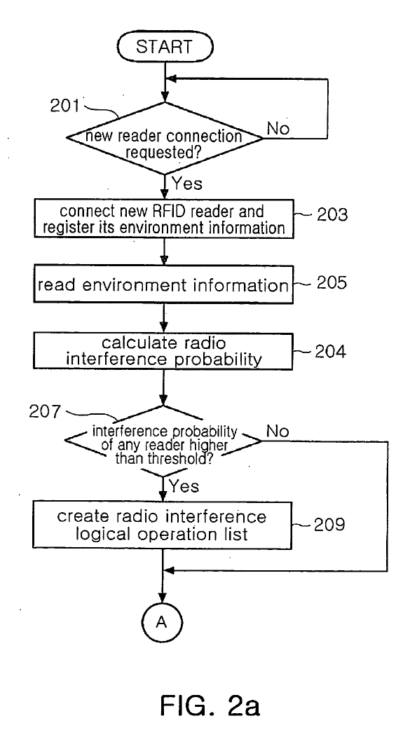

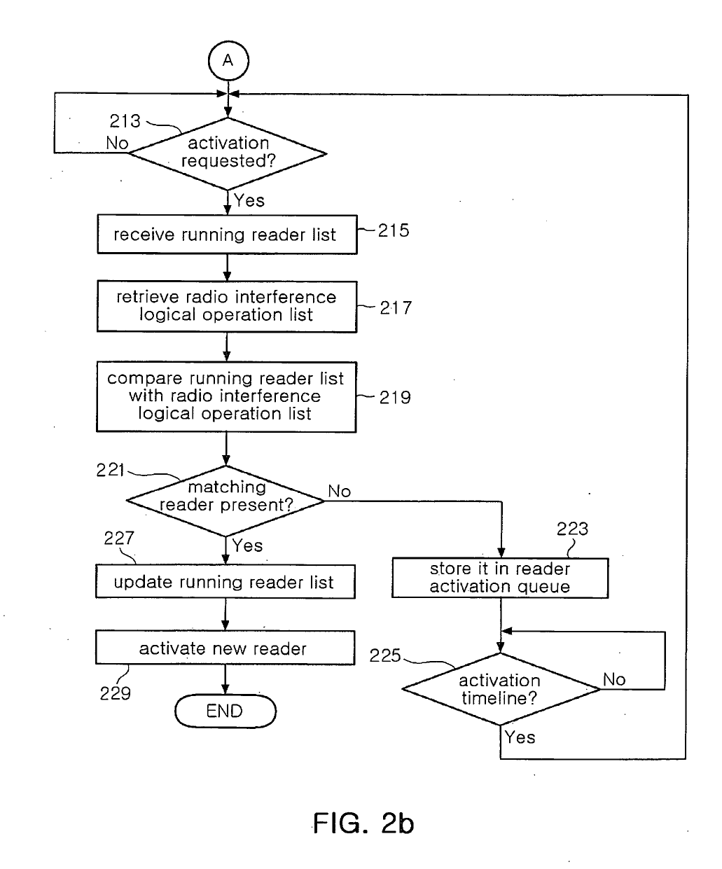

FIGS. 2a and 2b are flow charts of a procedure for preventing radio interference in the multiple RFID reader system according to an embodiment of the present invention.

As shown in FIG. 2a, at step 201, the multiple RFID reader control system 100 determines whether or not any reader has made a connection request through the TCP/IP protocol. If the reader 11 has made a request to connect to the system, at step 203, the multiple RFID reader control system 100 allows the reader 11 to be connected to the system 100 through the reader connection manager 110 and then dynamically receives its environment information such as position information and priority from the connected reader 11 and registers the received environment information in the reader environment information manager 150.

Then, at step 205, the multiple RFID reader control system 100 detects the IP address of the reader 11 and reads its environment information from the reader environment information manager 150 and then maintains the connection to the reader 11. Here, the reader connection manager 110 transmits the read environment information to the radio interference probability manager 120.

Then, at step 207, the multiple RFID reader control system 100 calculates probabilities of radio interference between the newly connected reader 11 and the already connected readers 12, 13, 14, 15, and 16 using the radio interference probability manager 120. The multiple RFID reader control system 100 calculates the radio interference probabilities by calculating distances between the newly connected RFID reader 11 and the already connected RFID readers 12 to 16. The radio interference between the newly connected reader 11 and each of the already connected readers 12, 13, 14, 15, and 16 increases as the distance between the newly connected reader 11 and each of the already connected readers decreases. The distances between the readers can be determined from their position information included in the environment information read from the reader environment information manager 150.

At step 209, the multiple RFID reader control system 100 compares the calculated probabilities with a threshold and determines whether or not any reader whose probability is higher than the threshold is present to select readers whose probabilities are higher than the threshold. If any reader with the higher probability is present, the multiple RFID reader control system 100 selects the reader and writes an ID and an IP address of the selected reader through the list manager 130 to create a radio interference logical operation list. If any reader with the higher probability is not present, the multiple RFID reader control system 100 proceeds to step 213.

At step 213, the multiple RFID reader control system 100 determines whether or not it has been requested that any connected reader be activated. If it has been requested that any connected reader be activated, the multiple RFID reader control system 100 receives a list of currently running readers at step 215 and retrieves a radio interference logical operation list stored in the list manager 130 at step 217. Then, at step 219, the multiple RFID reader control system 100 compares the running reader list with the retrieved radio interference logical operation list through the reader connection manager 110. Then, at step 221, the multiple RFID reader control system 100 determines, based on the comparison of step 219, whether or not any reader is included in both the running reader list and the retrieved radio interference logical operation list. If any reader is included in both the lists, the multiple RFID reader control system 100 denies the request to activate the reader 11 and stores information of the reader 11 in a reader activation queue 140 at step 223. Thereafter, at step 225, the multiple RFID reader control system 100 monitors activation times (also referred to as activation timelines) of the reader 11 through the reader connection manager 110 and returns to step 213 to repeat the request to activate the reader 11 at the next activation time after a specific time has passed, thereby allowing the reader connection manager 110 to reattempt to decide whether or not to activate the reader 11. This procedure allows the reader, whose information is stored in the reader activation queue 140, to be activated at its activation times when readers included in the logical operation list are not running.

On the other hand, if any reader is not included in both the running reader list and the radio interference logical operation list, at step 227, the multiple RFID reader control system 100 accepts the request to activate the newly connected reader 11 and updates the list of currently running readers by adding the information (ID and IP address) of the newly connected reader 11 to the currently running reader list. Then, at step 219, the multiple RFID reader control system 100 activates the newly connected reader 11.

The above description has been given of the procedure for controlling readers when a new reader has requested a connection to the multiple RFID reader control system 100 while some readers connected to the system 100 are running. Now, a procedure for controlling readers when a reader is removed from the readers running in the multiple RFID reader system according to another embodiment of the present invention will be described with reference to the accompanying drawings. This procedure will be described with reference to an example in which it has been requested that the reader 16 among the readers shown in FIG. 1 be removed.

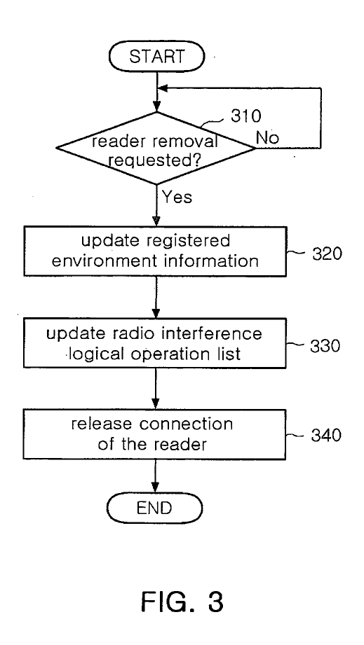

FIG. 3 is a flow chart of a procedure for preventing radio interference in the multiple RFID reader system when a reader is removed according to an embodiment of the present invention.

As shown in FIG. 3, at step 310, the multiple RFID reader control system 100 determines whether or not it has been requested that any reader be removed. If it has been requested that the reader 16 be removed, at step 320, the multiple RFID reader control system 100 removes the registered environment information of the reader 16 through the reader environment information manager 150. At step 330, the multiple RFID reader control system 100 updates the interference logical operation list by removing the information (ID and IP address) of the reader 16 through the list manager 130. Then, at step 340, the multiple RFID reader control system 100 releases the connection of the reader 16 which has been requested to be removed.

As is apparent from the above description, the present invention provides a multiple RFID reader system and a method for controlling multiple RFID readers in the system, which has a variety of advantages. For example, a radio interference logical operation list is created to prevent a newly connected reader from running simultaneously with an already connected reader which has a high probability of causing radio interference with the newly connected reader. This minimizes radio interference occurring when multiple RFID readers run together, thereby increasing their identification rates and thus increasing the operation efficiency of the system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for controlling multiple Radio Frequency Identification (RFID) readers in a multiple RFID reader system, the method comprising:
registering environment information of an RFID reader when the RFID reader is newly connected to the system;
calculating respective probabilities of radio interference between the newly connected RFID reader and already connected RFID readers;
creating a radio interference logical operation list using the calculated radio interference probabilities;
comparing the created radio interference logical operation list with a list of currently running RFID readers when a request to activate the newly connected RFID reader has been made; and
deciding whether or not to activate the newly connected RFID reader according to the comparison.

2. The method according to claim 1, further comprising:
removing registered environment information of an RFID reader, when a request to remove the RFID reader has been made, and updating the radio interference logical operation list of the newly connected RFID reader; and
releasing connection of the RFID reader which has been requested to be removed.

3. The method according to claim 2, further comprising:
when the request to remove the RFID reader has been made, updating lists of the RFID readers.

4. The method according to claim 1, wherein deciding whether or not to activate the newly connected RFID reader includes:
denying the request to activate the newly connected RFID reader if any of the currently running RFID readers is included in the radio interference logical operation list;
storing information of the newly connected RFID reader in a reader activation queue; and
again deciding whether or not to activate the newly connected RFID reader after a specific time.

5. The method according to claim 1, wherein deciding whether or not to activate the newly connected RFID reader includes:
accepting the request to activate the newly connected RFID reader if any of the currently running RFID readers is not included in the radio interference logical operation list;
updating the currently running RFID reader list by adding the newly connected RFID reader to the currently running RFID reader list; and
activating the newly connected RFID reader.

6. The method according to claim 1, wherein calculating the radio interference probabilities includes:
reading registered environment information of all the RFID readers connected to the system; and
calculating the respective probabilities of radio interference between the newly connected RFID reader and the already connected RFID readers by calculating distances between the newly connected RFID reader and the already connected RFID readers using the read environment information.

7. The method according to claim 6, wherein the radio interference logical operation list is created by selecting RFID readers, whose calculated radio interference probabilities are higher than a threshold, using Exclusive OR (XOR) operations and writing information of the selected RFID readers.

8. The method according to claim 2, wherein the environment information of the RFID readers includes respective identifiers (IDs), position information, IP addresses, priorities, and reader types of the RFID readers.

9. A multiple RFID reader system comprising:
a reader environment information manager that registers a new RFID reader when the new RFID reader is connected to the system and manages environment information of already connected RFID readers;
a radio interference probability manager that calculates and manages respective probabilities of radio interference between the new RFID reader and the already connected RFID readers;
a list manager that creates and manages a radio interference logical operation list using the calculated radio interference probabilities; and
a reader connection manager that manages connection of all the connected RFID readers and, when a request to activate the new RFID reader has been made, decides whether or not to activate the new RFID reader by comparing the created radio interference logical operation list with a list of currently running RFID readers.

10. The system according to claim 9, further comprising a reader activation queue that, when the request to activate the new RFID reader has been denied, stores information of the new RFID reader and makes a request to activate the new RFID reader after a specific time to allow the reader connection manager to again decide whether or not to activate the new RFID reader.

11. The system according to claim 9, wherein, when a request to remove an RFID reader has been made, the reader connection manager removes registered environment information of the RFID reader which has been requested to be removed and updates the radio interference logical operation list and then releases connection of the RFID reader which has been requested to be removed.

12. The system according to claim 9, wherein, if any of the currently running RFID readers is included in the radio interference logical operation list, the reader connection manager denies the request to activate the new RFID reader and then again decides whether or not to activate the new RFID reader after a specific time.

13. The system according to claim 12, wherein, if any of the currently running RFID readers is not included in the radio interference logical operation list, the reader connection manager accepts the request to activate the new RFID reader and updates the currently running RFID reader list by adding the new RFID reader to the currently running RFID reader list and then activates the new RFID reader.

14. The system according to claim 9, wherein the radio interference probability manager calculates the respective probabilities of radio interference between the new RFID reader and the already connected RFID readers by calculating distances between the new RFID reader and the already connected RFID readers using the registered environment information.

15. The system according to claim 14, wherein the environment information of the RFID readers includes respective identifiers (IDs), position information, IP addresses, priorities, and reader types of the RFID readers.

16. The system according to claim 9, wherein the list manager creates the radio interference logical operation list by selecting RFID readers, whose calculated radio interference probabilities are higher than a threshold, using Exclusive OR (XOR) operations and writing information of the selected RFID readers.

17. The system according to claim 9, wherein, when a request to remove an RFID reader has been made, the list manager manages updated lists of the RFID readers and the radio interference logical operation list by the reader connection manager.
